(19) United States
(12) Patent Application Publication
(10) Pub. No.: US 2005/0090245 A1
(43) Pub. Date: Apr. 28, 2005

(54) Mobile terminal with self performance diagnosis function and method thereof

(75) Inventor: Young-Ju Kim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/865,512

(22) Filed: Jun. 10, 2004

(30) Foreign Application Priority Data
Oct. 28, 2003 (KR) 75482/2003

(51) Int. Cl. H04B 1/44

(52) U.S. Cl. 455/425; 455/115.1; 455/566

(57) ABSTRACT

A mobile terminal with a self performance diagnosis function and a method thereof are provided. The mobile terminal has an RF switch connected between an output end of a transmitter and an input end of a receiver, for switching on in a diagnosis mode and feeding an RF signal received from the transmitter to the receiver. In the diagnosis mode, a test signal is applied to the transmitter, and the transmitter is operated by setting transmit power to a predetermined level. The RF switch turns on and operates the receiver. The received power level of a baseband signal received from the receiver is measured and compared with a predetermined threshold. A diagnosis result is displayed based on the level difference between the measured power level and the threshold. Therefore, the mobile terminal can diagnose its hardware performance on its own.

### PRIORITY

This application claims priority under 35 U.S.C. § 119 to an application entitled “Mobile Terminal with Self Performance Diagnosis Function and Method Thereof” filed in the Korean Intellectual Property Office on Oct. 28, 2003 and assigned Ser. No. 2003-75482, the contents of which are incorporated herein by reference.

### BACKGROUND OF THE INVENTION

1. Field of the Invention

The present invention relates generally to a mobile terminal, and in particular, to an apparatus and method for diagnosing hardware performance of a mobile terminal.

2. Description of the Related Art

A mobile terminal may experience performance degradation as its hardware characteristics deteriorate with the passage of time. In this case, or in the case where the mobile terminal is actually normal but the user thinks that its performance has degraded, he visits a service center to have the mobile terminal diagnosed. The service center diagnoses the performance of the mobile terminal by measuring its hardware characteristics through communication test equipment, a spectrum analyzer, a personal computer (PC), etc. An appropriate measure is taken based on the diagnosis. If the user is mistaken about the normal performance of the mobile terminal, it is understood that the mobile terminal operates well. If performance degradation or break-down actually occurs, the hardware characteristics are adjusted or a damaged part is replaced.

As described above, presently only the service center can diagnose the hardware performance characteristics of the mobile terminal. Therefore, the user must visit the service center if he thinks that the mobile terminal is not working properly. If the performance characteristics of the mobile terminal do not require hardware characteristic adjustment or part exchange, the visit is obviously unnecessary. Also, during diagnosing the mobile terminal in the service center, the user simply must wait and wastes time.

Moreover, the service center must be equipped with the aforementioned measuring equipment to measure the hardware characteristics and diagnose the performance of the mobile terminal. Such measuring equipment is usually expensive.

### SUMMARY OF THE INVENTION

An object of the present invention is to substantially solve at least the above problems and/or disadvantages and to provide at least the advantages below. Accordingly, an object of the present invention is to provide a mobile terminal that allows a user to easily diagnose its hardware performance characteristics, and a diagnosing method thereof.

Another object of the present invention is to provide a mobile terminal of which the hardware performance characteristics can be diagnosed without using measuring equipment, and a diagnosing method thereof.

The above objects are achieved by providing a mobile terminal with a self performance diagnosis function and a method thereof. The mobile terminal has an RF switch connected between an output end of a transmitter and an input end of a receiver, for switching on in a diagnosis mode and feeding an RF signal received from the transmitter to the receiver. In the diagnosis mode, a test signal is applied to the transmitter, and the transmitter is operated by setting transmit power to a predetermined level. The RF switch turns on and operates the receiver. The received power level of a baseband signal received from the receiver is measured and compared with a predetermined threshold. A diagnosis result is displayed based on the difference between the measured power level and the threshold.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a mobile terminal according to an embodiment of the present invention; and

FIG. 2 is a flowchart illustrating a mobile terminal self-diagnosing method according to the embodiment of the present invention.

### DETAILED DESCRIPTION OF THE PREFERRED EMBODIMENTS

A preferred embodiment of the present invention will be described herein below with reference to the accompanying drawings. In the following description, well-known functions or constructions are not described in detail to avoid obscuring the invention in unnecessary detail.

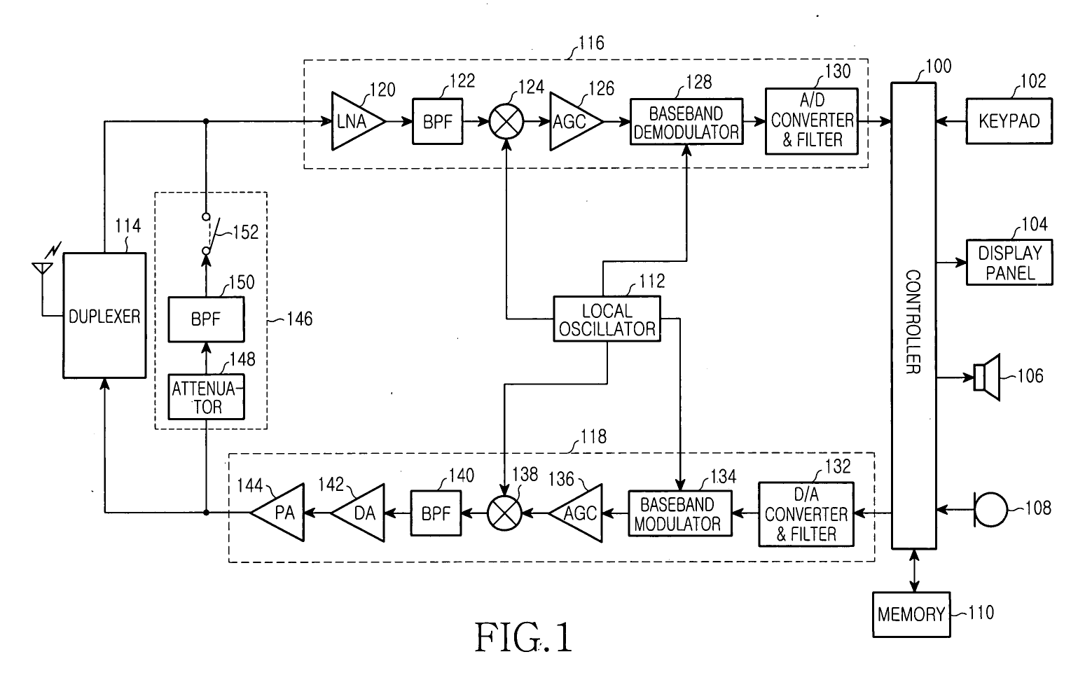

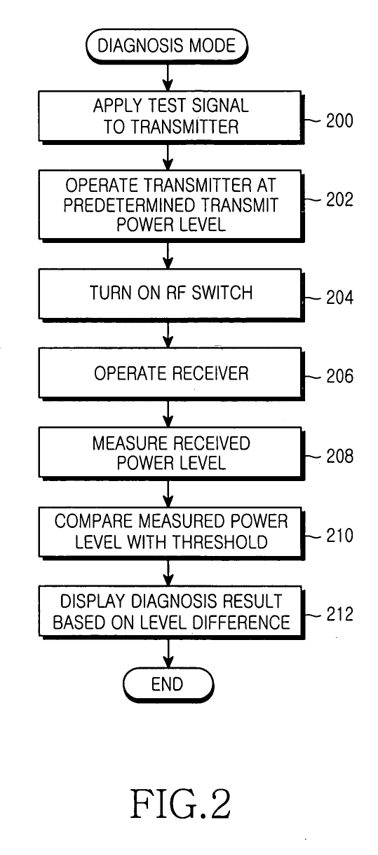

FIG. 1 is a block diagram of a mobile terminal according to an embodiment of the present invention. Referring to FIG. 1, the mobile terminal is configured so that a transmission/reception path connector 146 is additionally connected between a transmitter 118 and a receiver 116 common to mobile terminals, and a controller 100 performs a diagnosis procedure as illustrated in FIG. 2 according to the present invention. The transmitter 118 generates an RF signal corresponding to a transmission baseband signal received from the controller 100 and transmits the RF signal to an antenna through a duplexer 114. An RF signal received through the antenna is applied to the input of the receiver 116 through the duplexer 114. The receiver 116 generates a baseband signal corresponding to the RF signal and outputs it to the controller 100. The controller 100 is responsible for processing and controlling the functions of the mobile terminal, inclusive of voice call and data communication. In addition to the typical control function, the controller 100 further performs a self performance diagnosis function according to the present invention. The controller 100 is, for example, an MSM (Mobile Station Modem) of QUALCOMM. A keypad 102, having digit keys and function keys, provides key input data corresponding to a user-pressed key to the controller 100. A display panel 104 displays visual information under the control of the controller 100. A speaker 106 and a microphone 108 are connected to a CODEC (Coder-Decoder) inside the controller 100, for use in voice calls and voice recording. A memory 110 includes a ROM (Read Only Memory) for storing the microcodes of a process and control program for the controller 100 and reference data, a RAM (Random Access Memory) serving as a working memory for the controller 100, and a flash RAM for storing updatable data for preservation.

The receiver 116 and the transmitter 118 are schematically illustrated to help in understanding of the present invention. A local oscillator 112 is commonly related to the receiver 116 and the transmitter 118 and thus it is separately shown. In operation, the duplexer 114 separates an RF signal at a reception frequency from an RF signal received through the antenna. In the receiver 116, the RF signal is amplified in an LNA (Low Noise Amplifier) 120 and applied to the input of a mixer 124 through a BPF (Band Pass Filter) 122. The mixer 124 downconverts the RF signal received from the BPF 122 to an IF (Intermediate Frequency) signal by mixing the RF signal with an oscillation frequency received from the local oscillator 112. An AGC (Automatic Gain Controller) 126 controls the gain of the IF signal and a baseband demodulator 128 converts the IF signal to a baseband signal using an oscillation frequency received from the local oscillator. An A/D (Analog-to-Digital) converter and filter 130 digitizes the baseband signal and transmits it to the controller 100.

Meanwhile, in the transmitter 118, a D/A (Digital-to-Analog) converter and filter 132 converts a digital baseband transmission signal received from the controller 100 to an analog baseband signal. A baseband modulator 134 converts the analog baseband signal to an IF signal using a oscillation frequency received from the local oscillator and an AGC 136 controls the gain of the IF signal. A mixer 138 upconverts the IF signal received from the AGC 136 to an RF signal by mixing the IF signal with an oscillation frequency received from the local oscillator 112. A DA (Drive Amplifier) 142 amplifies the RF signal received through a BPF 140 and a PA (Power Amplifier) 144 amplifies the power of the amplified RF signal. The output of the PA 144 is transmitted to the antenna through the duplexer 114.

To diagnose the performance of hardware including the local oscillator 112, the transmitter 118 and the receiver 116 in the above-constituted mobile terminal, the transmission/reception path connector 146 with an attenuator 148, a BPF 150 and an RF switch 152 is interposed between the output end of the transmitter 118 and the input end of the receiver 116. The RF switch 152 switches on or off under the control of the controller 100. Only in a diagnosis mode, the RF switch 152 is turned on by the controller 100. With the RF switch 152 switched on, the RF signal output from the PA 144 of the transmitter 118 is applied to the input of the LNA 120 in the receiver 116 through the attenuator 148, the BPF 150 and the RF switch 152.

The diagnosis mode is set to enable the mobile terminal to autonomously diagnose its hardware performance according to the present invention. A user or a repairman can select the diagnosis mode through a menu or by a predetermined key input. If the user selects the diagnosis mode through the keypad 102, the controller 100 diagnoses the hardware performance of the mobile terminal on its own in steps 200 through 212 illustrated in FIG. 2 and displays the diagnosis result on the display panel 104.

Referring to FIG. 2, the controller 100 generates a test signal and transmits it to the transmitter 118 in step 200 and operates the transmitter 118 by setting transmit power to a predetermined level in step 202. The test signal is a digital signal in an arbitrary pattern by which to generate an RF signal in the transmitter 118, for diagnosis. Upon receipt of the test signal, the transmitter 118 generates the RF signal corresponding to the test signal. The PA 144 amplifies the RF signal to the predetermined transmit power level.

Meanwhile, the controller 100 switches on the RF switch 152 in step 204 and operates the receiver 116 in step 206. Thus, the RF signal output from the transmitter 118 is attenuated in the attenuator 148 and applied to the input of the receiver 116 through the BPF 150 and the RF switch 152. Here, the RF signal output from the transmitter 118 is at a higher power level than an RF signal received through the antenna. Application of the RF signal from the transmitter to the receiver 116 without any particular processing may impose a constraint on the receiver 116 or damage it because the receiver 116 is designed to receive a weak RF signal through the antenna and process it. That's why the attenuator 148 attenuates the RF signal from the transmitter 118 to an appropriate level for processing in the receiver. The BPF 150 passes the attenuated RF signal only in the reception frequency band.

In step 208, the controller 100 measures the received power of a baseband signal received from the receiver 116 in the same manner as typical receiver power level measuring. The controller 100 compares the receiver power measurement with a predetermined threshold in step 210 and displays a diagnosis result based on the difference between the received power measurement and the threshold on the display panel 104 in step 212.

Since the RF signal from the transmitter 118 includes noise, and this noise may negatively affect an RF signal received through the antenna, it is minimized through attenuation in the duplexer 114. However, the noise-including RF signal is applied to the receiver 116 and the level of the baseband signal from the receiver 116 corresponding to the RF signal is measured, to thereby diagnose the hardware performance in the present invention. As the hardware performance characteristics degrade, the noise increases in the transmitter 118 and the receiver 116. Thus, the hardware performance can be diagnosed by measuring the power level of the baseband signal corresponding to the noise-including RF signal at the output end of the receiver 116. Since the noise of the RF signal from the PA 144 increases with transmit power, it is preferable to set the transmit power to a maximum level in step 202 in order to diagnose the hardware performance under the worst condition. When the level of the baseband signal, which the receiver 116 outputs for the input of the RF signal corresponding to the test from the transmitter 118, is measured, the RF signal received through the antenna may be input to the receiver 116 through the duplexer 114, affecting the power level measuring. In consideration of this case, the frequency of the RF signal generated from the transmitter 118 in correspondence with the test signal and processed in the receiver 116 is preferably set to a frequency unused for actual mobile communication services. Alternatively, the RF signal from the duplexer 114 is blocked from the receiver 116 during operation in the diagnosis mode.

A comparative criterion is needed to diagnose the hardware performance from the measured received power level. For each mobile terminal model, a power level at which the hardware performance is considered good can be theoretically calculated or empirically obtained as the diagnosis criterion. However, considering that there are differences in hardware characteristics even between mobile terminals of the same model, it is preferred that a mobile terminal manufacturer performs the diagnosis mode operation in the process of fabrication, for example before delivery, and stores a receiver power level measured in steps 200 through 208 as a threshold in the memory 110 for use by the controller 100.

The diagnosis result displayed on the display panel 104 in step 212 can be diverse. For example, the difference between a received power level and a threshold is displayed so that the user or repairman can decide the degree of hardware performance degradation or whether the mobile terminal is seriously damaged. However, it is difficult for ordinary users to decide from the displayed difference value whether to visit a service center to get their mobile terminals fixed. Therefore, it is preferable to explicitly explain the meanings of level differences with regard to hardware performance in a user guide manual. Alternatively, a message indicating whether the hardware performance is good can be displayed on the display panel 104. That is, the controller 100 compares the level difference with a predetermined threshold and if it is greater than the threshold, the controller 100 displays a message indicating bad hardware performance as a diagnosis result. If the level difference is equal to or less than the threshold, the controller 100 displays a message indicating good hardware performance as the diagnosis result.

As described above, the present invention allows a mobile terminal to self-diagnose its hardware performance without the need of measuring equipment, and to display the diagnosis result. Therefore, a user or a repairman can easily decide the hardware performance characteristics of the mobile terminal.

As a result, the user does not need to visit a service center unnecessarily. Also, the service center diagnoses the performances of mobile terminals without the need of purchasing the measuring equipment. Hence, unnecessary part exchanges can be prevented.

While the invention has been shown and described with reference to a certain preferred embodiment thereof, it is a mere exemplary application. Although the transmission/reception path connector 146 is provided in a mobile terminal in the description, it can be fabricated in a detachable jig to be used in a service center, considering a cost increase involved in the installation of the transmission/reception path connector 146 in the mobile terminal. Then, the RF switch 152 in the jig is manipulated by a repairman in the service center. In this case, even though the user still has to visit the service center for diagnosis of the mobile terminal performance, the service center advantageously can diagnose the mobile terminal performance without using any particular measuring equipment. In addition, while the transmission/reception path connector 146 includes the attenuator 148 and the BPF 150 as well as the RF switch 152, they can be omitted or selectively used in real implementation. That is, setting the transmit power level based on an RF signal level suitable for input to the receiver 116 in step 202 will obviate the need of using the attenuator 148. The BPF 150 can also be omitted due to the presence of the BPF 122 in the receiver 116. Therefore, it will be understood by those skilled in the art that various changes in form and details may be made therein without departing from the spirit and scope of the invention as defined by the appended claims.

1. A self-diagnosis apparatus for diagnosing the performance of a mobile terminal having a transmitter for generating a radio frequency (RF) signal in correspondence with a baseband transmission signal and a receiver for generating a baseband signal in correspondence with a received RF signal, comprising:
an RF switch connected between an output end of the transmitter and an input end of the receiver, for switching on in a diagnosis mode and transmitting an RF signal received from the transmitter to the receiver; and
a controller for generating a test signal in the diagnosis mode, applying the test signal to the transmitter, operating the transmitter by setting transmit power to a predetermined level, switching the RF switch on, operating the receiver, measuring the received power level of a baseband signal received from the receiver, comparing the measured power level with a predetermined threshold, and displaying a diagnosis result based on the level difference between the measured power level and the threshold on a display.

2. The self-diagnosis apparatus of claim 1, wherein the controller stores a received power level measured in the diagnosis mode set during a fabrication process of the mobile terminal as the threshold in a memory.

3. The self-diagnosis apparatus of claim 1, wherein the RF switch is detachably installed in the mobile terminal.

4. The self-diagnosis apparatus of claim 1, further comprising an attenuator and a band pass filter (BPF) between the receiver and the RF switch.

5. The self-diagnosis apparatus of claim 4, wherein the RF switch, the attenuator and the BPF filter are detachably installed.

6. The self-diagnosis apparatus of claim 1, wherein the controller displays the level difference as the diagnosis result.

7. The self-diagnosis apparatus of claim 2, wherein the controller displays the level difference as the diagnosis result.

8. The self-diagnosis apparatus of claim 1, wherein the controller displays a message indicating bad hardware performance as the diagnosis result if the level difference is greater than a predetermined threshold, and a message indicating good hardware performance as the diagnosis result if the level difference is equal to or less than the predetermined threshold.

9. The self-diagnosis apparatus of claim 2, wherein the controller displays a message indicating bad hardware performance as the diagnosis result if the level difference is greater than a predetermined threshold, and a message indicating good hardware performance as the diagnosis result if the level difference is equal to or less than the predetermined threshold.

10. The self-diagnosis apparatus of claim 1, wherein the predetermined transmit power level is a maximum transmit power level.

11. The self-diagnosis apparatus of claim 2, wherein the predetermined transmit power level is a maximum transmit power level.

12. A self-diagnosis method for diagnosing the performance of a mobile terminal having a transmitter for generating a radio frequency (RF) signal in correspondence with a baseband transmission signal, a receiver for generating a baseband signal in correspondence with a received RF signal, and an RF switch connected between an output end of the transmitter and an input end of the receiver, comprising the steps of:
generating a test signal in a diagnosis mode, applying the test signal to the transmitter, and operating the transmitter by setting transmit power to a predetermined level;
switching the RF switch on and operating the receiver;
measuring the received power level of a baseband signal received from the receiver and comparing the measured power level with a predetermined threshold; and
displaying a diagnosis result based on the level difference between the measured power level and the threshold on a display.

13. The self-diagnosis method of claim 12, further comprising the step of storing a received power level measured in the diagnosis mode set during a fabrication process of the mobile terminal as the threshold in a memory.

14. The self-diagnosis method of claim 12, wherein the display step comprises the step of displaying the level difference as the diagnosis result.

15. The self-diagnosis method of claim 13, wherein the display step comprises the step of displaying the level difference as the diagnosis result.

16. The self-diagnosis method of claim 12, wherein the display step comprises the steps of:
displaying a message indicating bad hardware performance as the diagnosis result if the level difference is greater than a predetermined threshold; and
displaying a message indicating good hardware performance as the diagnosis result if the level difference is equal to or less than the predetermined threshold.

17. The self-diagnosis method of claim 13, wherein the display step comprises the steps of:
displaying a message indicating bad hardware performance as the diagnosis result if the level difference is greater than a predetermined threshold; and
displaying a message indicating good hardware performance as the diagnosis result if the level difference is equal to or less than the predetermined threshold.

18. The self-diagnosis method of claim 12, wherein the predetermined transmit power level is a maximum transmit power level.

19. The self-diagnosis method of claim 13, wherein the predetermined transmit power level is a maximum transmit power level.
